(19) United States
(12) Patent Application Publication
(10) Pub. No.: US 2011/0208818 A1
(43) Pub. Date: Aug. 25, 2011

(54) Location Messaging System

(75) Inventor: Lawrence Cruz, Chandler, AZ (US)

(73) Assignees: Lawrence Gerard Cruz, Chandler, AZ (US); Kristopher Paul Cruz, Chandler, AZ (US)

(21) Appl. No.: 12/821,133

(22) Filed: Jun. 23, 2010

Related U.S. Application Data
(60) Provisional application No. 61/223,030, filed on Jul. 4, 2009.

(51) Int. Cl. G06F 15/16

(52) U.S. Cl. 709/206

(57) ABSTRACT

A system for storing retrieving and presenting messages where the messages are associated with a physical location. The content of the messages can include all types of media, text, pictures, audio, video and raw data. Messages can be standalone messages or messages with any number of additional messages attached to them. The messages associated with physical locations are created by users of a variety of end device types such as smart phones or portable or stationary computing devices. Users search for messages while providing a physical location. Messages that are associated with a location that is within a specified distance of the provided location will be displayed by the end device. Some messages can be configured such that the associated location of the message changes automatically and periodically, giving the message the appearance of movement.

### CROSS-REFERENCE TO RELATED APPLICATIONS

This application claims the benefit of U.S. Provisional Application No. 61/223,030, filed Jul. 4, 2009

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### TECHNICAL FIELD

The present invention relates to the technical field of communication. More particularly, the communication of data and messages relative to physical locations.

### BACKGROUND

There are many methods for communicating data and messages from one physical location to another physical location or from one device to another device. The data and messages communicated can take on many forms such as electronic mail, short message service messages, multimedia messaging service messages and proprietary message formats.

There are many technologies and location based services that determine, specify or allow a person to specify a physical location on the planet Earth.

The present invention combines the communication of data messages with physical location resulting in stored and retrievable data messages that are relative to physical locations and physical locations that are relative to stored and retrievable data messages.

For example, consider the case where a person travels to a park to eat lunch at his favorite picnic table. This person could use an electronic device such as a computer, smart phone, tablet, etc. to create a message stating, “This is my favorite place to eat lunch and feed the ducks.” Rather than sending this message to a person, this person can post the message to the location. In this example, the location is the vicinity of his favorite picnic table. The message is then associated with the location. Another person may travel to the same park at another time while sitting at or near the same picnic table use her electronic device to look for messages associated with locations nearby. This person would be informed that there is indeed a message at or near their present location. She could then read the message left by the prior person and attach a reply to it that says, “Hey, this is my favorite place too! Did you know that the white duck has a name that he comes to?”

The two people in the prior example communicated with each other via messaging. However, the messages were not actually sent from one person to the other. Instead, they each posted messages to a message associated with a location. Neither person had to provide personal or private information to the other to communicate. The conversation can continue with each person attaching additional comments to the original message.

One of the compelling features of today's social networking websites is the ability to post a message and then enjoy the responses added to the original message. In the case of today's social networking sites, a person posts one of these messages to a web page associated with that person and the responses to the message are made by people in the person's social network. The present invention allows properly enabled electronic devices to post a message to a location where anybody with a properly enabled electronic device can read it and attach additional messages to it.

This disclosure will describe a system and method whereby messages, of any possible content, can be posted at locations and later read and modified by other users of the system and methods.

### BRIEF DESCRIPTION OF THE SEVERAL VIEWS OF THE DRAWINGS

The novel features believed to be characteristic of the present invention are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The present invention itself, however, as well as a preferred mode of use, further objectives and advantages thereof, will be best understood by reference to the following detailed description of illustrative embodiments when read in conjunction with the accompanying drawings, wherein:

FIG. 1 is a block diagram illustrating the exemplary components for a location messaging system in accordance with one aspect of the present application.

FIG. 2 is a simple diagram of an example embodiment of the present invention where the present invention is used to post and read messages associated with specific locations.

FIG. 3 is a simple diagram of an example embodiment of the present invention where the present invention is utilized to implement a game.

FIG. 4 is a simple diagram of an example embodiment of the present invention where the present invention is used to prove performance or compliance.

### DESCRIPTION OF THE INVENTION

The description set forth below in connection with the appended drawings is intended as a description of the presently-preferred embodiments of the present invention and is not intended to present the only form that the present invention can be constructed, utilized or implemented. The description sets forth the functions and the sequence of steps for constructing and operating the present invention in connection with the illustrated embodiments. It is to be understood, however, that the same or equivalent functions and sequences can be accomplished by different embodiments that are also intended to be encompassed within the spirit and scope of the present invention.

### Overview

Generally described, the present invention relates to messaging and more particularly, to a system providing for the communication and presentation of data and messages that are made relative to physical locations. In an exemplary embodiment, data and messages can be uploaded from at location devices to a database server. The data base server can then be queried from at location devices to search for data and messages at or near the location of the at location device. The database server can also be queried from at location devices for data and messages that are not associated with the current location of the at location device from the database server. An at location device can request data and messages from the database server for all data and messages created by or commented on by the at location device or user.

Data and messages associated with a location can have locations that actually change as time elapses. In an exemplary embodiment, data and messages can be created where the location is set to automatically change thereby moving the data and messages to new locations. Illustratively, this embodiment of the present invention would be analogous to a message in a bottle. A message that travels and can be discovered at different locations as it progresses to those locations.

There are many applications of the present invention. Those skilled in the relevant art will appreciate that other embodiments exist and are within the scope of the present invention. Further details regarding these embodiments as well as other features will become apparent from the discussion provided below.

### Location Messaging System

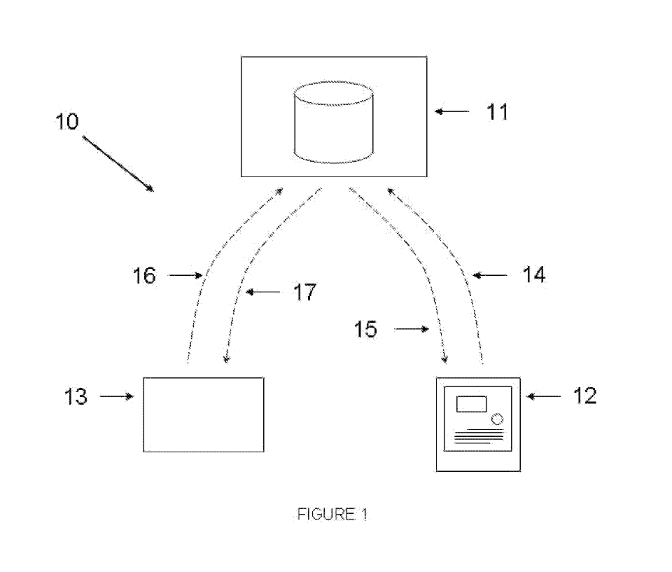

Referring now to the invention in more detail, in FIG. 1 there is shown a Location Messaging System 10. The Location Messaging System 10 comprises a Database Server 11 providing interfaces and data to end devices, namely an At Location Device 12 and a Web Browser Capable Device 13. Known to those skilled in the relevant art, fewer or more components can be used within the Location Messaging System 10. The components described herein represent one embodiment and should not be construed as the only embodiment. Each of these components within the Location Messaging System 10 will be described in more details below. While the term message is used, message can also be referred to as text, data, pictures, audio, video, multi-media, etc. and any combination of these. A message can be a standalone message or a message that has additional messages attached to it. While one of the components is identified as a Web Browser Capable Device this does not limit the implementation of the present invention for this or any component to be contained within a web browser. In fact, this and any component can be implemented in any variety of frameworks or environments. Each of the components described herein can be implemented in hardware, software or a combination of both. While two of the components are identified as “At Location Device” and a “Web Browser Capable Device” these components are embodiments of an “End Device.”

As shown, The Location Messaging System 10 can include an At Location Device 12 that communicates data and messages 14 to the Database Server 11. Any method may be utilized to communicate the data and messages. The Database Server 11 communicates data and messages 15 to the At Location Device 12. Any method may be utilized to communicate the data and messages. The Web Browser Capable Device 13 communicates data and messages 16 to the Database Server 11. Any method may be utilized to communicate the data and messages. The Database Server 11 communicates data, messages and possibly web pages 17 to the Web Browser Capable Device 13. Any method may be utilized to communicate the data and messages.

In further detail, still referring to the invention of FIG. 1, The Database Server 11 stores data and messages in a database and provides programmatic and web based interfaces to access the stored data and messages. The At Location Device 12 is any end device that can determine or be informed of its physical location. The device may be portable or “hand held” such as a smart phone or portable computer but it may also be stationary such as a kiosk. The Web Browser Capable Device 13 is any form of computer that operates a web browser or presentation and user interaction interfaces.

The At Location Device 12 communicates 14 its physical location to the Database Server 11 and requests data, messages or message information from the Database Server 11. The Database Server 11 looks in its database for messages associated with the specified physical location. The Database Server 11 then replies 15 with data, messages or information about messages to the At Location Device 12. By doing this, the At Location Device can then display, or make available for display, messages stored in the database that are associated with the specified physical location. The messages can be simple text, pictures, audio, video or any combination thereof. In this way, the Location Messaging System 10 serves as a virtual bulletin board with the At Location Device 12 serving as a reader of the virtual bulletin board.

The Web Browser Capable Device 13 requests 16 data, messages, message information or web pages from the Database Server 11. The Database Server 11 responds 17 with data, messages, message information and web pages to the Web Browser Capable Device 13. The Web Browser Capable Device 13 presents a data management interface to the user of Web Browser Capable Device 13. In addition, the Web Browser Capable Device 13 also has the same capabilities as the At Location Device 12. When the Web Browser Capable Device 13 is performing the same capabilities of the At Location Device 12, the physical location specified does not have to be the actual physical location of the Web Browser Capable Device 13. The physical location specified may originate from a map, mapping program or entered manually.

The advantages of the present invention include, without limitation, the ability to post and read messages associated with a given physical location. The messages can be posted or read by any person using an At Location Device 12. The messages can contain and convey any kind of information such as advertising for a specific location such as, “50% off at this store.” Another application is general message posting such as, “This is where Harry proposed to Sally” or “I ordered the steak at this restaurant and it was fantastic!” A person with an At Location Device 12, when arriving at a physical location can inquire or be automatically informed that there are messages associated with the person's current physical location or locations nearby. Another benefit of the present invention is that it allows a single person to essentially send a message to multiple people without having to know who those people are or when they will receive the message. The message remains posted for anybody to read at any time. The present invention is not limited to making all posted messages available to all people but may also provide an option for controlling access to posted messages. The present invention is not limited by the purpose, reason or content of messages. Whether the purpose of the message is to mark a location, make a proclamation, offer insight, or to socialize, etc., the present invention provides for the existence of these messages regardless of the intended purpose. In broad embodiment, the present invention is a system that allows stored and retrievable messages of any type for any purpose to be associated with a physical location.

### Applications

Following are several embodiments of the present invention. These embodiments are not intended to limit the scope of the present invention. These embodiments are simply examples of the many possible applications of the present invention. Those skilled in the relevant art will appreciate that a large variety of applications of the present invention are possible.

### Simple Location Based Messaging

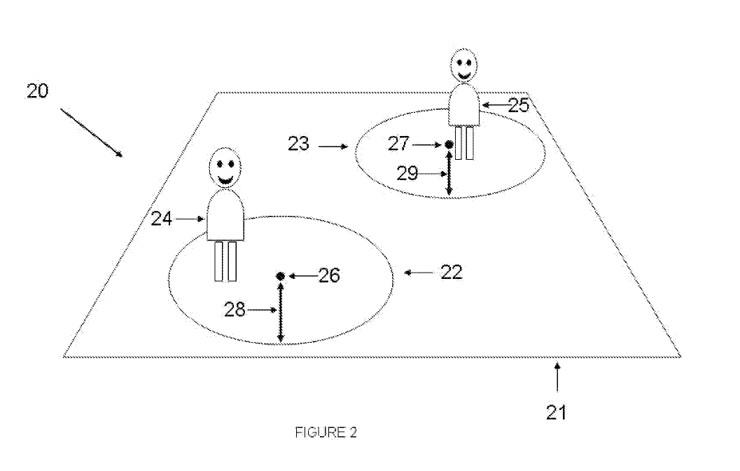

Referring now to the invention in more detail, in FIG. 2 is shown an example embodiment of the present invention, Simple Location Based Messaging 20 comprising all possible locations 21, a specific location 22, a second specific location 23, a person 24 standing within the specific location 22 and a second person 25 standing within the specific location 24. All possible locations 21 represents, currently, any location on the planet Earth. The specific location 22 comprise a point 26 and a radius 28 defining a circular area. The specific location 23 comprise a point 27 and a radius 29 defining a circular area. A point, such as 26 and 27, is a specific location in all of space. In the present invention the specification of a point is not limited to latitude, longitude and height. There may be other systems used to identify a point in space unique from all other points in space. The method for identifying a point may be the Global Positioning System (GPS) or any other means such as relative signal strength from known points or a system like Right Ascension and Declination. Regardless of the location system and the method for determining a point in that system, the present invention utilizes points within a system identified by some means.

Any location is an area. In this example the location is depicted as a circular area defined by a point and a radius. This is one example of specifying an area. The present invention is not limited to locations being specified as circular areas. Location may be areas defined by multiple points forming triangular, rectangular and irregular shaped areas. An area is not limited to being 2 dimensional. The location includes all space above and below the specified area. An area can be small, for example, one square foot or may be large and measured in square miles or kilometers.

Referring again to FIG. 2 as an example embodiment of the present invention, there is a person 24 standing at or within location 22. There is also a person 25 standing at or within location 23. In this example each person is carrying a handheld GPS capable device such as a smart phone. The present invention allows person 24 to create a message using the smart phone and then send it to the FIG. 1 Location Messaging System 10. The message may be simple text stating “Hi, Bob here! I am standing at the very spot where I hit a grand slam today!” The present invention stores the message and the location, FIG. 2 component 22, on the FIG. 1 Database Server 11. The present invention has now recorded a message from person 24 sent from location 22. Later, person 25 standing at or within location 23 travels to location 22. The present invention allows person 25 to use the handheld device to query the FIG. 1 Location Messaging System 10 asking if there are any messages at this new location 22. The FIG. 1 Location Messaging System 10 searches its database and finds that there is indeed a message associated with location 22 and sends that message to the handheld device of person 25. Person 25 can then read the message that was left earlier at location 22 by person 24. Person 25 can then use the handheld device to add another message to be associated with location 22. The message may be simple text or text accompanied with multimedia stating, “That's funny because this is the exact same spot where I pitched 3 strikes to a guy named Bob.” Both messages left by person 24 and 25 are now stored in the FIG. 1 Location Messaging System 10 and available to the next person or persons entering location 22. The present invention allows people entering location 22 with their handheld GPS capable devices to check with the FIG. 1 Location Messaging System 10 for any messages that might be at that location. The present invention also makes it possible for a person to be notified upon arriving at or passing through a location that there is a message or messages associated with that location. The present invention also allows for a person to read all messages associated with a physical location even while not at the physical location providing the person had previously posted a message at that physical location. In other words, for this example, person 24 could be sitting at home and check with FIG. 1 Location Messaging System 10 to see if another person posted a message at the same location where person 24 previously posted.

### A Game of Clues

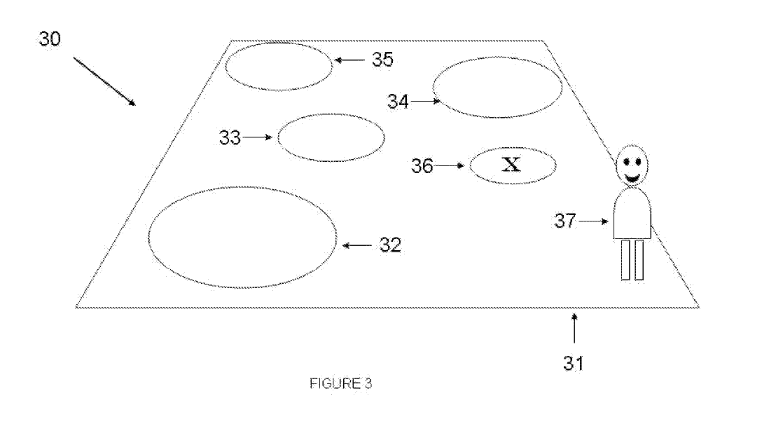

A form of this game is often called “Treasure Hunt.” Referring now to the invention in more detail, in FIG. 3 is shown an example embodiment of the present invention, “A game of clues” 30 comprising all possible locations 31, specific locations 32, 33, 34, 35, 36 and a person 37. In this game the game organizer first travels to location 32 and posts a message at that location using the present invention. The game organizer then travels to each of the other specified locations and posts a message at each of these locations using the present invention. The message that the game organizer posts at location 32 provides a clue to where location 33 is. An example message might be, “Welcome to the game! Follow clues to all of the locations to construct a clue to the final location where the prize is waiting. Your first clue is ‘What crosses the river but doesn't move?’” Similarly, the game organizer travels to location 33 and posts a message at that location that is a clue to where location 34 is. This continues through any number of locations until the final location 36 is reached. The present invention, FIG. 1 Location Messaging System 10 now has a message stored for each of the specific locations 32, 33, 34, 35, and 36. A person 37 playing in the game starts at location 32 and uses the present invention to look for a message at that location. Upon finding the message posted by the game organizer the person 37 interprets it as a clue to the next location that the player must find. In this example the player should be looking for a location that is a “bridge.” The players in the game follow clues from location to location. The first person to reach location 36, the final location, and reads the message there and posts a comment to that message is declared the winner of the game.

### Proof of Performance

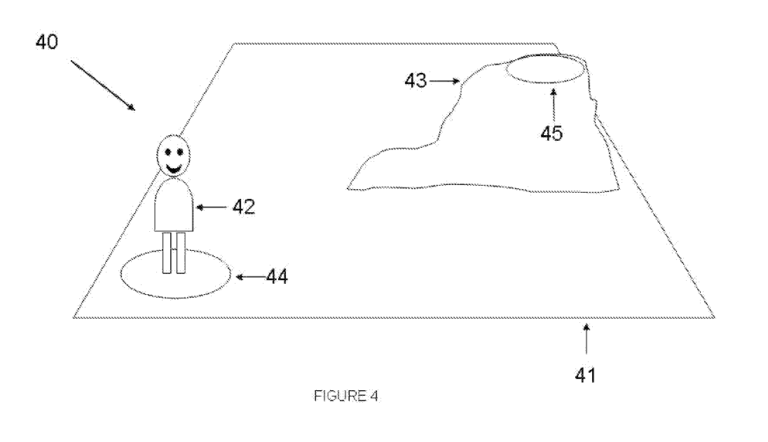

Referring now to the invention in more detail, in FIG. 4 is shown an example embodiment of the present invention, “Proof of performance” 40 comprising all possible locations 41, a person 42, a mountain 43, and specific locations 44 and 45. In this example, the present invention is used to prove that an event occurred leveraging the posting of messages from specific locations stored in the FIG. 1 Location Messaging System 10. Each message, when posted from a specific location, is stamped with the time that the message was posted. This time stamp information is also recorded by the FIG. 1 Location Messaging System 10. In this example, the person 42 wants to prove that he can climb the mountain 43 and that he can climb that mountain in a given amount of time. The person 42 starts at specific location 44 and utilizes the present invention to post a message. The message could say, “This is Gina and I am at the base of the mountain and starting my climb.” The person 42 would then climb the mountain to the specific location 45. The person 42 would then utilize the present invention to post a message at location 45. The message could say, “This is Gina and I am at the top of the mountain. I made it in record time! Just try to beat that!”

There are many scenarios possible other than the mountain climbing scenario. The essential utilization of the present invention is to prove that a person was at a specific location at a specific time. In fact, the proof may not be absolute as the FIG. 1 Location Messaging System 10 confirms that the FIG. 1 At Location Device 12 was at a specific location at a specific time. This does not necessarily prove by itself that the person was at a specific location at a specific time. In the future it may be possible to link an actual person's location to the location of the FIG. 1 At Location Device 12. This will allow the FIG. 1 Location Messaging System 10 to provide stronger proof that a person was at a specific location.

### Message in a Bottle

The present invention can be used to create a virtual “message in a bottle.” In this example embodiment of the present invention, a message is associated with a specific location but that location changes over time. The present invention allows for a person to post a message at a specific location and specify that the message is to move from its original location to other locations. This example is similar to a message in a bottle being carried from one location to another in the ocean. The present invention allows the location of the original message to change over time, thus the message travels from one location to another. As the message travels from one location to another the present invention allows other persons at the new locations to see the message and attach additional messages to the original message. For example, a person could post a message at a location that is their home and specify that the message is to travel, possibly in a specified direction, possibly at a specified speed. The message posted could be, “Hello to the world! From Frank in Napa Valley, Calif.!” As time passes, the location of the message is changed by FIG. 1 Location Messaging System 10 from its original location to a new location. As more time passes, the location of the message changes again, and again, and again. At any time, the message has a location and any person at that location can look for messages associated with that location. If a person sees that there is a travelling message currently at their location the person can choose to add a message to the original message. For example, a person may add, “Hi Frank! Your message has made it to Seattle, Wash.!” The present invention makes it possible to continue changing the message's location indefinitely. The present invention makes it possible for the original person posting the message to view all of the messages attached to his original message at any time without having to be at the message's current location. Since the present invention allows a person to view their travelling message even when the current location of the message is not the same as the current location of the person, it is also possible for the person to view his or her message and all messages attached or added to it from any FIG. 1 Web Browser Capable Device 13. Essentially, the present invention allows a person to create a virtual message in a bottle. The present invention allows others, who encounter the virtual message in a bottle, to add messages to the bottle. The present invention allows the person who created the original message in the virtual bottle to track the virtual bottle and read all of the messages added to it using FIG. 1 at location device 12 or FIG. 1 Web Browser Capable Device 13.

### Survey

The present invention can be used to conduct surveys of users of the present invention. In this embodiment, the user selects and responds to a survey using the end device. This will record not only the survey response but the location of where the end device was when the survey was taken. The resulting collection of survey data could then be displayed on a map or listed by location to provide a geographic perspective on survey results.

A survey may be comprised of one or more questions. For example, a survey question may be, “Do you prefer warm or cold climates?” The response to the survey is sent to the FIG. 1 Location Messaging System 10 and stored in the FIG. 1 Database Server 11. The resulting collection of survey data would present a perspective of climate preferences relative to location.

In this example embodiment of collecting and presenting survey data, the survey response is an embodiment of a message contained in and maintained by FIG. 1 Location Messaging System 10 and associated with a location.

The foregoing descriptions are provided to enable any person skilled in the relevant art to practice the various embodiments described herein. Various modifications to these embodiments will be readily apparent to those skilled in the relevant art, and generic principles defined herein can be applied to other embodiments. Thus the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

The embodiments of the invention in which an exclusive property or privilege is claimed are defined as follows:

1. A System comprising:
an end device creating and displaying messages;
wherein said messages for display on said end device are maintained by a centrally controlled network and said messages are each associated with a location.

2. The system of claim 1, wherein said messages comprises text, pictures, audio, video, multi-media and other said messages.

3. The system of claim 1, wherein said end device is any portable or stationary computing device capable of communicating with said centrally controlled network.

4. The system of claim 1, wherein said end device determines and expresses the locations to be associated with said messages.

5. The system of claim 1, wherein the expressed locations associated with said messages are determined by means outside of said end device.

6. The system of claim 1, wherein said end device creates and uploads said messages to said centrally controlled network.

7. The system of claim 1, wherein said end device creates and uploads said messages as additions to existing said messages.

8. The system of claim 1, wherein said end device creates and uploads said messages wherein the location of said message will be automatically and periodically changed over time according to a specified or randomly selected direction, speed, destination, distance or specified area to change the location within.

9. The system of claim 1, wherein said end device requests said messages based on a specified location or the current location of said end device or the identity of said end device or the identity of the owner of said end device or any combination thereof.

10. The system of claim 1, wherein said centrally controlled network comprises a repository for storing said messages and associated locations.

11. A server comprising:
a repository storing said messages, locations, associated locations, identity and associated capabilities for viewing said messages on said end devices;
at least one processor; and
a memory operatively coupled to said processor, said memory storing program instructions that when executed by said processor causes said processor to:
respond to requests from said end devices with data, said messages and data about said messages stored in said repository.
perform notifications to external entities when said messages are created.
perform periodic adjustments to said repository.
allow maintenance of said stored messages.

12. The server of claim 11, wherein said server responds to requests from said end devices for said messages and data concerning said messages and provides said messages and data concerning messages to said end devices.

13. The server of claim 11, wherein said server searches for said messages, for any purpose, in said repository based on the location and associated locations of said messages or identity of said end device or identity of the owner of said end device.

14. The server of claim 11, wherein said server responds to requests from said end devices to delete a specific said message.

15. The server of claim 11, wherein said server publishes notifications of activity within the system of claim 1 to a component of said server or an entity external to the server of claim 11.

16. The system of claim 1 and claim 10 that enables end devices and users of end devices to share said messages and data concerning said messages without the need to share personal user information or end device information with other users or other user's end devices.

17. The system of claim 1 and claim 10 that provides the ability to access, for any purpose, all said messages created by one or more identified said end devices or by one or more identified users of said end devices.

18. The system of claim 1 and claim 10 that provides the ability to restrict access or visibility of said message or said message content based on location or any other criteria.

19. The system of claim 1 and claim 10 that provides the ability to access, for any purpose, a said message chosen at random from the said repository.

20. The system of claim 1 and claim 10 that provides the ability to perform surveys and associate the survey response with the location where said end device was located at the time the survey was responded to.
